(19) United States
(12) Patent Application Publication
(10) Pub. No.: US 2026/0039620 A1
(43) Pub. Date: Feb. 5, 2026

(54) TECHNOLOGIES RELATED TO MUTE FUNCTIONALITY IN TEXT-BASED MESSAGING APPLICATIONS

(71) Applicant: GENESYS CLOUD SERVICES, INC., MENLO PARK, CA (US)

(72) Inventors: NICOLAS KREBS, GUIPAVAS (FR); FABIAN LE DOEUFF, GUIPAVAS (FR)

(73) Assignee: GENESYS CLOUD SERVICES, INC., MENLO PARK, CA (US)

(21) Appl. No.: 18/790,167

(22) Filed: Jul. 31, 2024

(51) Int. Cl. H04L 51/224; G06F 3/0484; G06F 40/279; G06F 40/35; H04L 51/212

(52) U.S. Cl. CPC H04L 51/224; G06F 3/0484; G06F 40/279; G06F 40/35; H04L 51/212

(57) ABSTRACT

A method of selectively generating message notifications for chat messages to a user of a chat channel. The method includes: activating a mute feature for the chat channel; activating an auto-unmute feature for the chat channel; receiving a search target defining a message characteristic; receiving a first new message; analyzing the first new message to determine if the message characteristic of the search target is present in the first new message; if the search target is determined to not be present in the first new message, maintaining the mute feature so that, in relation to the first new message, no message notification is generated; and if the search target is determined to be present in the first new message, overriding the mute feature so that, in relation to the first new message, a first message notification is generated.

### BACKGROUND

The present invention generally relates to customer relations services and customer relations management via contact centers and associated cloud-based systems. More particularly, but not by way of limitation, the present invention pertains to features and functionality related to text-based messaging or chat applications. As will be seen, in accordance with exemplary embodiments, the present invention includes functionality related to a chat channel muting feature that includes notifications when certain user specified keywords or topics (or “search targets”) are detected in an incoming message.

### BRIEF DESCRIPTION OF THE INVENTION

The present invention includes a computer-implemented method of selectively generating message notifications in relation to respective messages to a user via a user device, wherein the messages are text-based chat messages posted on a chat channel to which the user is subscribed. The method includes: activating a mute feature in relation to the chat channel, wherein the mute feature, once activated, is configured to suppress a generation of message notifications associated with respective new messages posted to the chat channel, wherein the new messages are defined as the messages posted to the chat channel subsequent to the activation of the mute feature; activating an auto-unmute feature in relation to the chat channel; receiving one or more search targets, the one or more search targets each being a message characteristic; and performing, when the auto-unmute feature is activated, a first process for selectively overriding the mute feature in relation to the new messages. When described in relation to an exemplary first new message of the new messages that is representative as to how the first process operates in relation to each of the new messages, the first process includes: receiving the first new message; analyzing the first new message to determine if the message characteristics of the one or more search targets are present in the first new message; if the one or more search targets are determined to not be present in the first new message, maintaining the mute feature so that, in relation to the first new message, no message notification is generated; and if the one or more search targets are determined to be present in the first new message, overriding the mute feature so that, in relation to the first new message, a first message notification is generated.

These and other features of the present application will become more apparent upon review of the following detailed description of the example embodiments when taken in conjunction with the drawings and the appended claims.

### BRIEF DESCRIPTION OF THE DRAWINGS

A more complete appreciation of the present invention will become more readily apparent as the invention becomes better understood by reference to the following detailed description when considered in conjunction with the accompanying drawings, in which like reference symbols indicate like components, wherein:

FIG. 1 depicts a schematic block diagram of a computing device in accordance with exemplary embodiments of the present invention and/or with which exemplary embodiments of the present invention may be enabled or practiced;

FIG. 2 depicts a schematic block diagram of a communications infrastructure or contact center in accordance with exemplary embodiments of the present invention and/or with which exemplary embodiments of the present invention may be enabled or practiced;

FIG. 3 is a simplified data flow sequence diagram for a chat system in accordance with exemplary operation of embodiments of the present invention;

FIG. 4 is an exemplary method demonstrating exemplary chat functionality of an embodiment of the present invention; and

FIG. 5 is an exemplary chat user interface facilitating a conventional mute feature;

FIG. 6 is an exemplary chat user interface facilitating an auto-unmute feature in accordance with embodiments of the present invention;

FIG. 7 is an exemplary chat user interface facilitating an auto-unmute feature in accordance with alternative embodiments of the present invention; and

FIG. 8 is an exemplary method demonstrating alternative chat functionality of an alternative embodiment of the present invention.

### DETAILED DESCRIPTION

For the purpose of promoting an understanding of the principles of the invention, reference will now be made to the exemplary embodiments illustrated in the drawings and specific language will be used to describe the same. It will be apparent, however, to one having ordinary skill in the art that the detailed material provided in the examples may not be needed to practice the present invention. In other instances, well-known materials or methods have not been described in detail in order to avoid obscuring the present invention. Additionally, further modification in the provided examples or application of the principles of the invention, as presented herein, are contemplated as would normally occur to those skilled in the art. Particular features, structures or characteristics may be combined in any suitable combinations and/or sub-combinations in one or more embodiments or examples. Those skilled in the art will recognize that various embodiments may be computer implemented using many different types of data processing equipment, with embodiments being implemented as an apparatus, method, or computer program product. Example embodiments, thus, may take the form of a hardware embodiment, a software embodiment, or combination thereof.

### Computing Device

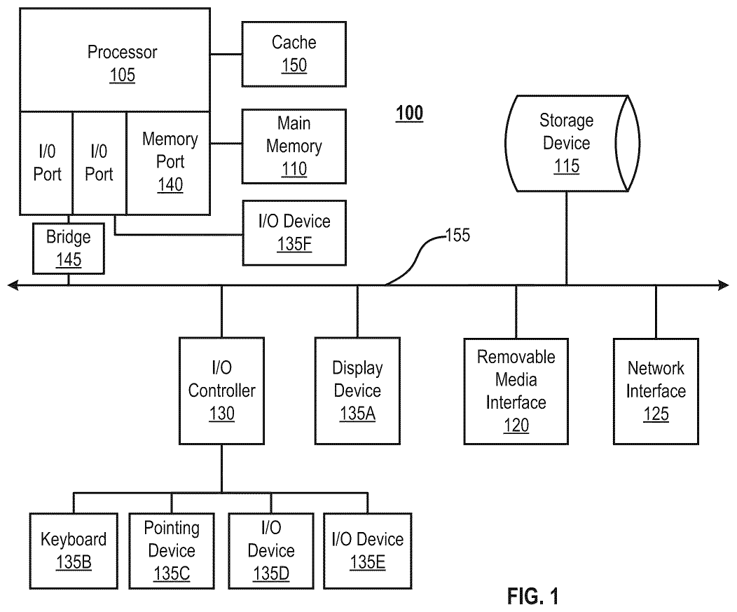

The present invention may be computer implemented using different forms of data processing equipment, for example, digital microprocessors and associated memory, executing appropriate software programs. By way of background, FIG. 1 illustrates a schematic block diagram of an exemplary computing device 100 in accordance with embodiments of the present invention and/or with which those embodiments may be enabled or practiced.

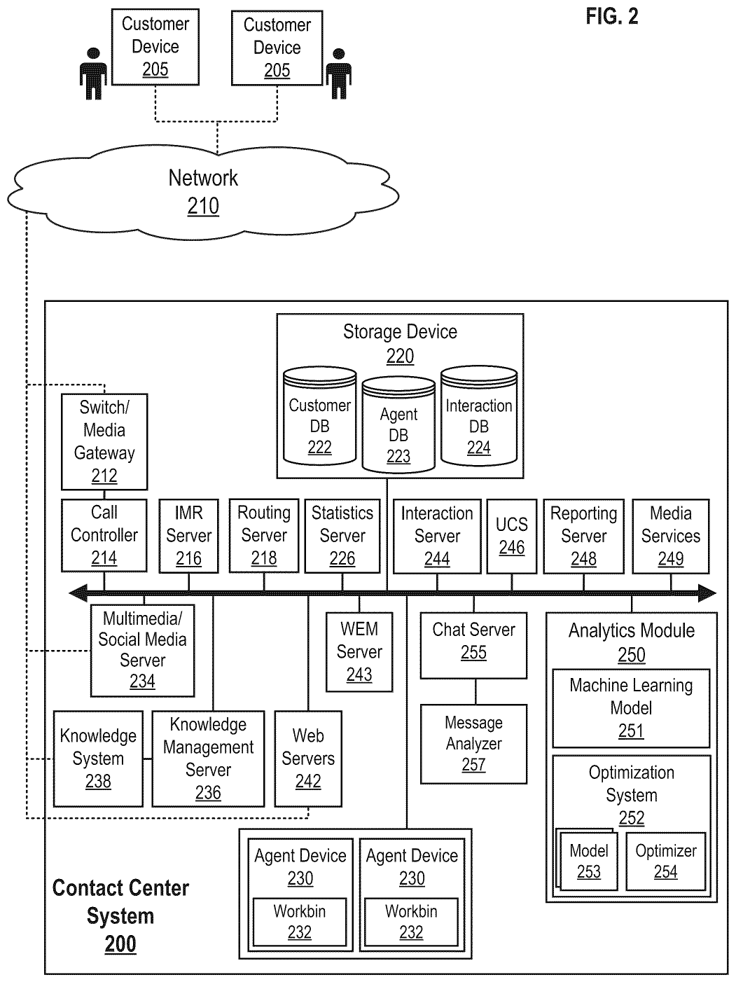

The computing device 100, for example, may be implemented via firmware (e.g., an application-specific integrated circuit), hardware, or a combination of software, firmware, and hardware. Each of the servers, controllers, switches, gateways, engines, and/or modules in the following figures (which collectively may be referred to as servers or modules) may be implemented via one or more of the computing devices 100. As an example, the various servers may be a process running on one or more processors of one or more computing devices 100, which may be executing computer program instructions and interacting with other systems or modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described in the following figures-such as, for example, the contact center 200 of FIG. 2—the various servers and computer devices thereof may be located on local computing devices 100 (i.e., on-site or at the same physical location as contact center agents), remote computing devices 100 (i.e., off-site or in a cloud computing environment, for example, in a remote data center connected to the contact center via a network), or some combination thereof. Functionality provided by servers located on off-site computing devices may be accessed and provided over a virtual private network (VPN), as if such servers were on-site, or the functionality may be provided using a software as a service (SaaS) accessed over the Internet using various protocols, such as by exchanging data via extensible markup language (XML), JSON, and the like.

As shown in the illustrated example, the computing device 100 may include a central processing unit (CPU) or processor 105 and a main memory 110. The computing device 100 may also include a storage device 115, removable media interface 120, network interface 125, I/O controller 130, and one or more input/output (I/O) devices 135, which as depicted may include an, display device 135A, keyboard 135B, and pointing device 135C. The computing device 100 further may include additional elements, such as a memory port 140, a bridge 145, I/O ports, one or more additional input/output devices 135D, 135E, 135F, and a cache memory 150 in communication with the processor 105.

The processor 105 may be any logic circuitry that responds to and processes instructions fetched from the main memory 110. For example, the processor 105 may be implemented by an integrated circuit, e.g., a microprocessor, microcontroller, or graphics processing unit, or in a field-programmable gate array or application-specific integrated circuit. As depicted, the processor 105 may communicate directly with the cache memory 150 via a secondary bus or backside bus. The main memory 110 may be one or more memory chips capable of storing data and allowing stored data to be accessed by the central processing unit 105. The storage device 115 may provide storage for an operating system, which controls scheduling tasks and access to system resources, and other software. Unless otherwise limited, the computing device 100 may include an operating system and software capable of performing the functionality described herein.

As depicted in the illustrated example, the computing device 100 may include a wide variety of I/O devices 135, one or more of which may be connected via the I/O controller 130. Input devices, for example, may include a keyboard 135B and a pointing device 135C, e.g., a mouse or optical pen. Output devices, for example, may include video display devices, speakers, and printers. More generally, the I/O devices 135 may include any conventional devices for performing the functionality described herein.

Unless otherwise limited, the computing device 100 may be any workstation, desktop computer, laptop or notebook computer, server machine, virtualized machine, mobile or smart phone, portable telecommunication device, media playing device, or any other type of computing, telecommunications or media device, without limitation, capable of performing the operations and functionality described herein. The computing device 100 may include a plurality of such devices connected by a network or connected to other systems and resources via a network. Unless otherwise limited, the computing device 100 may communicate with other computing devices 100 via any type of network using any conventional communication protocol.

### Contact Center

With reference now to FIG. 2, a communications infrastructure or contact center system (or simply “contact center”) 200 is shown in accordance with exemplary embodiments of the present invention and/or with which exemplary embodiments of the present invention may be enabled or practiced. By way of background, customer service providers generally offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals” or “customers”). For example, the agents at a contact center may assist customers in making purchasing decisions, receiving orders, or solving problems with products or services already received. Within a contact center, such interactions between agents and customers may be conducted over a variety of communication channels, such as, for example, via voice (e.g., telephone calls or voice over IP or VOIP calls), video (e.g., video conferencing), text (e.g., emails and text chat), screen sharing, co-browsing, or the like.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize automated processes in place of live agents, such as interactive voice response (IVR) systems, interactive media response (IMR) systems, internet robots or “bots”, automated chat modules or “chatbots”, and the like.

Referring specifically to FIG. 2, the contact center 200 may be used by a customer service provider to provide various types of services to customers. For example, the contact center 200 may be used to engage and manage interactions in which automated processes (or bots) or human agents communicate with customers. The contact center 200 may be an in-house facility of a business or enterprise for performing the functions of sales and customer service relative to products and services available through the enterprise. In another aspect, the contact center 200 may be operated by a service provider that contracts to provide customer relation services to a business or organization. Further, the contact center 200 may be deployed on equipment dedicated to the enterprise or third-party service provider, and/or deployed in a remote computing environment such as, for example, a private or public cloud environment with infrastructure for supporting multiple contact centers for multiple enterprises. The contact center 200 may include software applications or programs, which may be executed on premises or remotely or some combination thereof. It should further be appreciated that the various components of the contact center 200 may be distributed across various geographic locations.

Unless otherwise specifically limited, any of the computing elements of the present invention may be implemented in cloud-based or cloud computing environments. As used herein, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture”, a cloud execution model generally includes a service provider dynamically managing an allocation and provisioning of remote servers for achieving a desired functionality.

In accordance with the illustrated example of FIG. 2, the components or modules of the contact center 200 may include: a plurality of customer devices 205; communications network (or simply “network”) 210; switch/media gateway 212; call controller 214; interactive media response (IMR) server 216; routing server 218; storage device 220; statistics server 226; plurality of agent devices 230 that each have a workbin 232; multimedia/social media server 234; knowledge management server 236 coupled to a knowledge system 238; web servers 242; interaction server 244; universal contact server (or “UCS”) 246; reporting server 248; media services server 249; an analytics module 250; and a chat server 255 and related message analyzer 257. It should be understood that any of the computer-implemented components, modules, or servers described in relation to FIG. 2 or in any of the following figures may be implemented via computing devices, such as the computing device 100 of FIG. 1. As will be seen, the contact center 200 generally manages resources (e.g., personnel, computers, telecommunication equipment, etc.) to enable the delivery of services via telephone, email, chat, or other communication mechanisms. The various components, modules, and/or servers of FIG. 2 (and other figures included herein) each may include one or more processors executing computer program instructions and interacting with other system components for performing the various functionalities described herein. Further, the terms “interaction” and “communication” are used interchangeably, and generally refer to any real-time and non-real-time interaction that uses any communication channel including, without limitation, telephone calls (PSTN or VOIP calls), emails, voicemails, video, chat, screen-sharing, text messages, social media messages, WebRTC calls, etc. Access to and control of the components of the contact system 200 may be affected through user interfaces (UIs) which may be generated on the customer devices 205 and/or the agent devices 230.

Customers desiring to receive services from the contact center 200 may initiate inbound communications (e.g., telephone calls, emails, chats, etc.) to the contact center 200 via a customer device 205. While FIG. 2 shows two such customer devices it should be understood that any number may be present. The customer devices 205, for example, may be a communication device, such as a telephone, smart phone, computer, tablet, or laptop. In accordance with functionality described herein, customers may generally use the customer devices 205 to initiate, manage, and conduct communications with the contact center 200, such as telephone calls, emails, chats, text messages, web-browsing sessions, and other multi-media transactions. Inbound and outbound communications from and to the customer devices 205 may traverse the network 210, with the nature of network typically depending on the type of customer device being used and form of communication. As an example, the network 210 may include a communication network of telephone, cellular, and/or data services. The network 210 may be a private or public switched telephone network (PSTN), local area network (LAN), private wide area network (WAN), and/or public WAN such as the Internet. Further, the network 210 may include a wireless carrier network including a code division multiple access network, global system for mobile communications (GSM) network, or any wireless network/technology conventional in the art.

The switch/media gateway 212 may be coupled to the network 210 for receiving and transmitting telephone calls between customers and the contact center 200. The switch/media gateway 212 may include a telephone or communication switch configured to function as a central switch for agent routing within the center. The switch may be a hardware switching system or implemented via software. For example, the switch 215 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 230. In general, the switch/media gateway 212 establishes a voice connection between the customer and the agent by establishing a connection between the customer device 205 and agent device 230. The switch/media gateway 212 may be coupled to the call controller 214 which, for example, serves as an adapter or interface between the switch and the other routing, monitoring, and communication-handling components of the contact center 200. The call controller 214 may be configured to process PSTN calls, VOIP calls, etc. The call controller 214 may include computer-telephone integration (CTI) software for interfacing with the switch/media gateway and other components. The call controller 214 may extract data about an incoming interaction, such as the customer's telephone number, IP address, or email address, and then communicate these with other contact center components in processing the interaction.

The interactive media response (IMR) server 216 enables self-help or virtual assistant functionality. Specifically, the IMR server 216 may be similar to an interactive voice response (IVR) server, except that the IMR server 216 is not restricted to voice and may also cover a variety of media channels. In an example illustrating voice, the IMR server 216 may be configured with an IMR script for querying customers on their needs. Through continued interaction with the IMR server 216, customers may receive service without needing to speak with an agent. The IMR server 216 may ascertain why a customer is contacting the contact center so to route the communication to the appropriate resource.

The routing server 218 routes incoming interactions. For example, once it is determined that an inbound communication should be handled by a human agent, functionality within the routing server 218 may select the most appropriate agent and route the communication thereto. This type of functionality may be referred to as predictive routing. Such agent selection may be based on which available agent is best suited for handling the communication. More specifically, the selection of appropriate agent may be based on a routing strategy or algorithm that is implemented by the routing server 218. In doing this, the routing server 218 may query data that is relevant to the incoming interaction, for example, data relating to the particular customer, available agents, and the type of interaction, which, as described more below, may be stored in particular databases. Once the agent is selected, the routing server 218 may interact with the call controller 214 to route (i.e., connect) the incoming interaction to the corresponding agent device 230. As part of this connection, information about the customer may be provided to the selected agent via their agent device 230, which may enhance the service the agent is able to provide.

Regarding data storage, the contact center 200 may include one or more mass storage devices—represented generally by the storage device 220—for storing data in one or more databases. For example, the storage device 220 may store customer data that is maintained in a customer database 222. Such customer data may include customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 220 may store agent data in an agent database 223. Agent data maintained by the contact center 200 may include agent availability and agent profiles, schedules, skills, average handle time, etc. As another example, the storage device 220 may store interaction data in an interaction database 224. Interaction data may include data relating to numerous past interactions between customers and contact centers. More generally, it should be understood that, unless otherwise specified, the storage device 220 may be configured to include databases and/or store data related to any of the types of information described herein, with those databases and/or data being accessible to the other modules or servers of the contact center 200 in ways that facilitate the functionality described herein. For example, the servers or modules of the contact center 200 may query such databases to retrieve data stored therewithin or transmit data thereto for storage.

The statistics server 226 may be configured to record and aggregate data relating to the performance and operational aspects of the contact center 200. Such information may be compiled by the statistics server 226 and made available to other servers and modules, such as the reporting server 248, which then may produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 230 of the contact center 200 may be communication devices configured to interact with the various components and modules of the contact center 200 to facilitate the functionality described herein. An agent device 230, for example, may include a telephone adapted for regular telephone calls or VOIP calls. An agent device 230 may further include a computing device configured to communicate with the servers of the contact center 200, perform data processing associated with operations, and interface with customers via voice, chat, email, and other multimedia communication mechanisms according to functionality described herein. While only two such agent devices are shown, any number may be present.

The multimedia/social media server 234 may be configured to facilitate media interactions (other than voice) with the customer devices 205 and/or the servers 242. Such media interactions may be related, for example, to email, voicemail, chat, video, text-messaging, web, social media, co-browsing, etc. The multi-media/social media server 234 may take the form of any IP router conventional in the art with specialized hardware and software for receiving, processing, and forwarding multi-media events and communications.

The knowledge management server 234 may be configured to facilitate interactions between customers and the knowledge system 238. In general, the knowledge system 238 may be a computer system capable of receiving questions or queries and providing answers in response. The knowledge system 238 may include an artificially intelligent computer system capable of answering questions posed in natural language by retrieving information from information sources such as encyclopedias, dictionaries, newswire articles, literary works, or other documents submitted to the knowledge system 238 as reference materials, as is known in the art.

The web servers 242 provide site hosts for a variety of social interaction sites to which customers subscribe, such as Facebook, Twitter, Instagram, etc. Though depicted as part of the contact center 200, it should be understood that the web servers 242 may be provided by third parties and/or maintained remotely. The web servers 242 may also provide webpages for the enterprise or organization being supported by the contact center 200. For example, customers may browse the webpages and receive information about the products and services of a particular enterprise. Within such enterprise webpages, mechanisms may be provided for initiating an interaction with the contact center 200, for example, via web chat, voice, or email. An example of such a mechanism is a widget, which can be deployed on the webpages or websites hosted on the web servers 242. As used herein, a widget refers to a user interface component that performs a particular function. In some implementations, a widget includes a GUI that is overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Such widgets may include additional user interfaces and be configured to access a variety of local resources (e.g., a calendar or contact information on the customer device) or remote resources via network (e.g., instant messaging, electronic mail, or social networking updates).

The interaction server 244 is configured to manage deferrable activities of the contact center and the routing thereof to human agents for completion. As used herein, deferrable activities include back-office work that can be performed off-line, e.g., responding to emails, attending training, and other activities that do not entail real-time communication with a customer.

The universal contact server (UCS) 246 may be configured to retrieve information stored in the customer database 222 and/or transmit information thereto for storage therein. For example, the UCS 246 may be utilized as part of the chat feature to facilitate maintaining a history on how chats with a particular customer were handled, which then may be used as a reference for how future chats should be handled. More generally, the UCS 246 may be configured to facilitate maintaining a history of customer preferences, such as preferred media channels and best times to contact. To do this, the UCS 246 may be configured to identify data pertinent to the interaction history for each customer, such as data related to comments from agents, customer communication history, and the like. Each of these data types then may be stored in the customer database 222 or on other modules and retrieved as functionality described herein requires.

The reporting server 248 may be configured to generate reports from data compiled and aggregated by the statistics server 226 or other sources. Such reports may include near real-time reports or historical reports and concern the state of contact center resources and performance characteristics, such as, for example, average wait time, abandonment rate, agent occupancy. The reports may be generated automatically or in response to a request and used toward managing the contact center in accordance with functionality described herein.

The media services server 249 provides audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), speech recognition, dual tone multi frequency (DTMF) recognition, audio and video transcoding, secure real-time transport protocol (SRTP), audio or video conferencing, call analysis, keyword spotting, etc.

The analytics module 250 may be configured to perform analytics on data received from a plurality of different data sources as functionality described herein may require. The analytics module 250 may also generate, update, train, and modify predictors or models, such as machine learning model 251 and/or models 253, based on collected data. To achieve this, the analytics module 250 may have access to the data stored in the storage device 220, including the customer database 222 and agent database 223. The analytics module 250 also may have access to the interaction database 224, which stores data related to interactions and interaction content (e.g., audio and transcripts of the interactions and events detected therein), interaction metadata (e.g., customer identifier, agent identifier, medium of interaction, length of interaction, interaction start and end time, department, tagged categories), and the application setting (e.g., the interaction path through the contact center). The analytic module 250 may retrieve such data from the storage device 220 for developing and training algorithms and models. It should be understood that, while the analytics module 250 is depicted as being part of a contact center, the functionality described in relation thereto may also be implemented on customer systems (or, as also used herein, on the “customer-side” of the interaction) and used for the benefit of customers.

The machine learning model 251 may include one or more artificial intelligence-based models, including machine learning models, such as neural networks, deep learning models as well as other types as described herein. As an example, the machine learning model 251 may be configured to predict behavior. Such behavioral models may be trained to predict the behavior of customers and agents in a variety of situations so that interactions may be personally tailored to customers and handled more efficiently by agents. As another example, the machine learning model 251 may be configured to predict aspects related to contact center operation and performance. In other cases, for example, the machine learning model 251 also may be configured to perform natural language processing and, for example, provide intent recognition and the like.

The analytics module 250 may further include an optimization system 252. The optimization system 252 may include one or more models 253, which may include the machine learning model 251, and an optimizer 254. The optimizer 254 may be used in conjunction with the models 253 to minimize a cost function subject to a set of constraints, where the cost function is a mathematical representation of desired objectives or system operation. Because the models 253 are typically non-linear, the optimizer 254 may be a nonlinear programming optimizer. It is contemplated, however, that the optimizer 254 may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like. The analytics module 250 may utilize the optimization system 252 as part of an optimization process by which aspects of contact center performance and operation are optimized or, at least, enhanced. This, for example, may include aspects related to the customer experience, agent experience, interaction routing, natural language processing, intent recognition, allocation of system resources, system analytics, or other functionality related to automated processes.

The chat server 255 may be configured to conduct, orchestrate, and manage electronic chat communications with customers and/or other participants. Such chat communications may be conducted by the chat server 255 in such a way that a customer communicates with automated chatbots, human agents, or both. The chat server 255 may perform as a chat orchestration server that dispatches chat conversations among chatbots and available human agents. In such cases, the processing logic of the chat server 255 may be rules driven so to leverage an intelligent workload distribution among available chat resources. The chat server 255 further may implement, manage and facilitate user interfaces (also UIs) associated with the chat feature. The chat server 255 may be configured to transfer chats within a single chat session with a particular customer between automated and human sources. The chat server 255 may be coupled to the knowledge management server 234 and the knowledge systems 238 for receiving suggestions and answers to queries posed by customers during a chat so that, for example, links to relevant articles can be provided. As discussed below, the chat server 255 may provide functionality in relation to one or more chat channels, such as those related to particular topics, groups of participants, etc. The chat server 255 may be configured as a chat engine that is configured to provide one or more chat channels. The chat server 255 also may interact with chat channels hosted via other chat servers or chat engines. As shown, the chat server 255 may operate in connection with a message analyzer 257. As discussed below, the message analyzer 257 may analyze text messages for particular characteristics, such as topics, keywords, sentiment, etc. (which generally may be referred to as search targets). The chat server 255 and the message analyzer 257 may further orchestrate other components, servers, and modules of a contact center and the data related thereto, such as those components, servers, and modules described above in relation to the contact center 200, so to provide the functionality described herein, as would be understood by one of ordinary skill in the art.

### Enhanced Muting Functionality for Text-Based Messaging

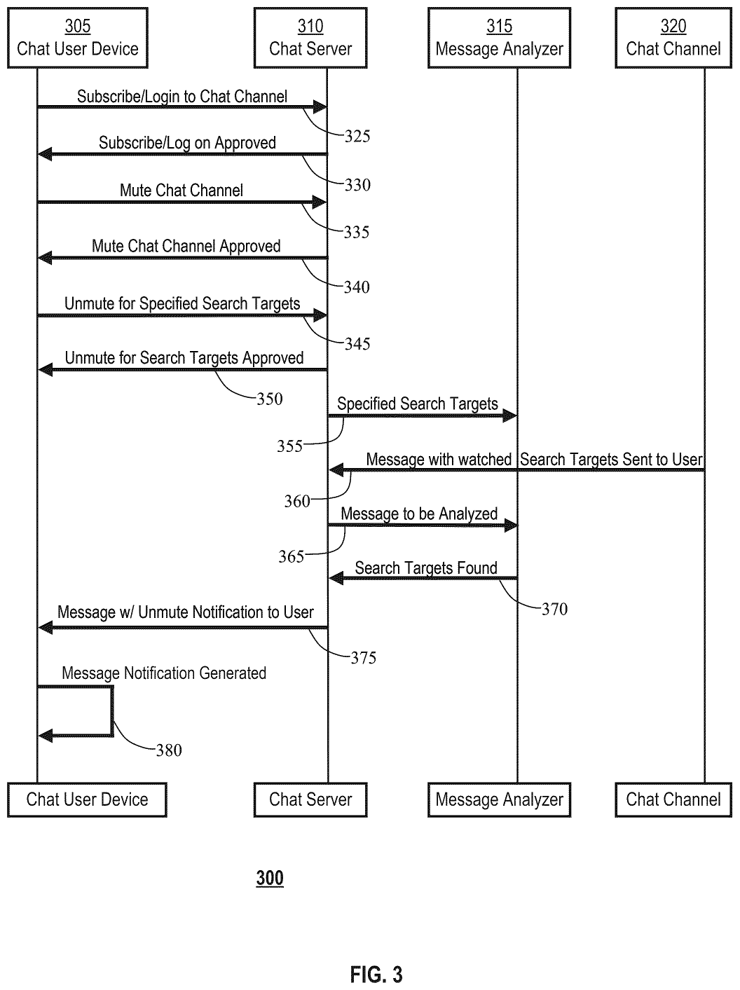

Turning now to FIGS. 3-8, the functionality of the chat server 255 and message analyzer 257 will now be further described in accordance with example embodiments of the present invention. Before proceeding with this, though, some background will be provided as to how text-based or chat messaging functions. While this is done, certain operational shortcomings will be highlighted that the present invention is intended to address.

As will be appreciated, text-based messaging or, simply, chat is a method of communication whereby textual character strings can be sent and received as messages. Messages can be exchanged between people or automated computer systems in order to communicate information or initiate commands. Common user interfaces for text-based messaging include email, text terminals, programming shells, Instant Messaging (IM), Internet Relay Chat (IRC), and Short Message Service (SMS). Desktop computers, video game consoles, electronic book readers, printers, televisions, and mobile phones are devices commonly equipped with text-based messaging capabilities. As would be appreciated, a chat engine is typically configured to provide one or more chat channels. A chat (or chat session) may refer to a type of communication over the network that provides real-time/close to real-time transmission of messages between users of the chat. Messages may include visual information (e.g., text, icon, symbol, image, video, graph), audio information (e.g., audio, sound clips), and/or other information. Messages may include one or more topics/subjects. For example, a message posted using chat may include information about or relating to a person or thing, a location, a map, a graph, a media item (e.g., picture, sound clip, presentation, video), and/or other text/data objects.

Chat channels denote virtual spaces or platforms wherein users can partake in text-based communication or conversations, either on a one-on-one basis or within a group setting. For example, a chat may be formed to discuss particular topics or subject matter (such as a particular person, object, artifact, and/or search) and the chat may include (or be associated with) one or more channels to view particular aspects/types of information posted within the chat. As another example, a chat may be formed to discuss a general topic and the chat may include (or be associated with) one or more channels that each correspond to a specific sub-topic of the general topic. Thus, a chat channel may refer to a text communication channel that is dedicated to a given topic or subject or group of participants.

A chat user may be associated with several different chat channels that have active, ongoing conversations. The importance of each of these conversations to the chat user often varies greatly. For example, in some of the conversations, the chat user may be very involved in the conversation and desire to know when each new message is posted to the chat channel so that the user stays current with all new incoming information. On the other hand, in other conversations, the chat user may not be interested in knowing each new detail arriving with newly posted messages. Instead the chat user may desire to be more peripherally involved in the conversation and reach messages and/or post responses only when certain topic come up. Nevertheless, irrespective of interest level, the incoming messages posted to each of the chat channels generally cause the device of the chat user to generate the same message notification. As used herein, a “message notification” is a notification generated to notify a chat user of the new message. Such message notifications typically include a visual indicator, such as a pop up or push notification, which is generated within a user interface displayed on the device of the chat user. Additionally, such message notifications typically include a sound indicator, such as a chime or tone or other noise, which is generated by the device for audibly notifying the user of new messages. Whatever the case, a chat user often finds it difficult to keep track of the message activity occurring across all ongoing chat channels and associated conversations. Chat users can become visually inundated with pop visual indicators or audibly inundated by sound indicators that are generated in response to new messages being received within their chat channels. This can be distracting and bothersome to the user. Further, such inundation can distract a chat user, as important information arriving in certain chat channels is missed in the flood of unwanted information.

As a result, chat applications generally have what is generally referred to as a “mute feature”, which the user can activate in relation to particular chat conversations or channels. Though the manner can vary as to how such functionality is delivered, the mute feature typically provides a way for the chat user to turn off message notification associated with certain chat channels. In general, the chat user can select a particular chat channel and then activate the mute feature in regard to that channel. This action may further be described as turning the mute feature on or muting the selected channel. As will be appreciated, this may also be applied to particular chat conversations or chat channels and, unless otherwise stated, it will be appreciated that the terms “chat conversation” and “chat channel” may be used interchangeably herein.

Once a chat channel has been muted, the chat user ceases to receive message notifications for any new messages that are posted to the chat channel. While new messages on a muted chat channel may still be accessed or viewed by the user within the particular chat channel, the mute feature prevents the chat application from providing any of the message notifications that would otherwise be provided if the chat channel where not muted. Thus, the push notifications or pop ups or other visual indicator would not be generated to notifying the user of a new message on a muted chat channel. Further, activation of the mute feature prevents the generation of sound indicators. In other cases, activation of the mute feature affects other changes in relation to the muted chat channel. For example, the user interface for the chat application may visually deprioritize a chat channel that has been muted. As an example of this, the muted chat channel may no longer appear in the home screen of the chat application or may be moved to the bottom of a listing of chat channels or conversations. In short, when a user mutes a particular chat channel or conversation, the user is still included in the conversation but does not receive any message notifications associated with new messages that would otherwise be generated but for the chat channel being muted.

As a result, when a chat channel is muted by a user, the user becomes uninformed as to messaging activity occurring within the mute channel. This can lead to the user not knowing that a message has arrived that contains information that is important or useful to the user. Of course, the user can make it a point to manually check a muted chat channel periodically for new messages that contain such information. But, even for the most diligent user, this course of action typically results in important messages going unnoticed and/or being missed by the user. Further, certain messages are time sensitive so that, unless the user is constantly performing such manual checks of muted chat channels, important information still may be missed because the user fails to perform such checks often enough.

In accordance with embodiments of the present invention, an auto-unmute feature is proposed to ensure important topics or information are not missed in muted chat channels. In an example of operation, when the user mutes notifications for a particular chat channel, the auto-unmute feature checks, via a message analyzer, each new message added in the channel flow if data inside the message matches the user-specified search targets, e.g., keywords, topics, or other message characteristics. If the search target is found in the new message, a message notification is generated to indicate that a new message that is likely of interest to the user is present on the muted chat channel. Thus, in exemplary embodiments, the message analyzer searches messages in the background for messages that contain user specified search targets.

As used herein, the term “search target” refers to user-defined message characteristics that, when detected in one or more of the messages appearing within a muted chat channel, triggers the unmuting of the channel. The chat user then receives a message notification, for example, via a visual and/or sound indicator, which notifies them of the messages that triggered the auto-unmute feature. As used herein, the message(s) that trigger the auto-unmute feature to unmute a chat channel is referred to as the “triggering message(s)”. The search targets may include different types of message characteristics and/or combinations thereof. For example, search targets may include user specified keywords or topics that are detected as appearing within the triggering messages. In other embodiments, such as in cases where the feature is employed in relation to agents in a contact center, the incoming messages may be analyzed in relation to intent or sentiment characteristics, which may form the basis of other message characteristics that are used as search targets. Additional information related to such message characteristics as well as other types and how each may be detected in conversational text can be found in U.S. application Ser. No. 18/441,701, filed on Feb. 14, 2024, entitled “Methods and Systems for Generating Taxonomy Analytics for Aspects of Contact Center Interactions”, the content of which is incorporated herein by reference.

Additionally, the rate of messaging (i.e., how fast messages are being posted on the muted chat channel) may form another type of search target. In such cases, the chat user may be notified if the rate of incoming messages exceeds a maximum threshold, the occurrence of which may signal the likelihood that something noteworthy is being discussed on a muted chat channel.

In accordance with certain embodiments, each search target type may be combined with the others to form a plurality of search targets (i.e., message characteristics) that must be detected to trigger the unmuting of a conversation. For example, a user may specify as search targets a particular topic and a negative sentiment level. In such a case, the message analyzer would have to detect the particular topic and the specified level of negative sentiment before a conversation would be unmuted. In certain embodiments, each new message is analyzed separately by the message analyzer. In other embodiments, each new message is analyzed in combination with a predetermined number of previous messages just posted to the muted chat channel, which allows for new messages to be contextualized via the messages occurring just before it. Thus, the message analyzer may analyze single or multiple messages within a given chat channel to determine whether the one or more specified search targets are present.

Thus, the functionality associated with the present auto-unmute feature allows a chat user to mute notifications associated with a particular chat channel—thereby potentially avoiding the flood of notifications that come with the chat channel—while still staying informed as to when particular characteristics are detected that signal a new message has a high likelihood of importance. Implementation of this may occur within instant messaging or chat channels of all types. In certain embodiments, implementation occurs on desktop graphical user interfaces. In other embodiments, the auto-unmute feature is implemented on smart phones and other similar devices.

With reference now to FIG. 3, a simplified data flow sequence diagram 300 is provided that demonstrates data flow between various network components according to an exemplary embodiment. The network components may include a chat user device 305, chat server 310, message analyzer 315, and chat channel 320. Initially, in accordance with exemplary embodiments, the chat user device 305 may transmit data 325 to the chat server 310 allowing the chat user to subscribe or login to the chat channel 320. Once the data is received and has been verified by the chat server 310, the chat server 310 may respond by transmitting data 330 to the chat user device 305 approving the subscription and/or allowing the device to login to the chat channel 320.

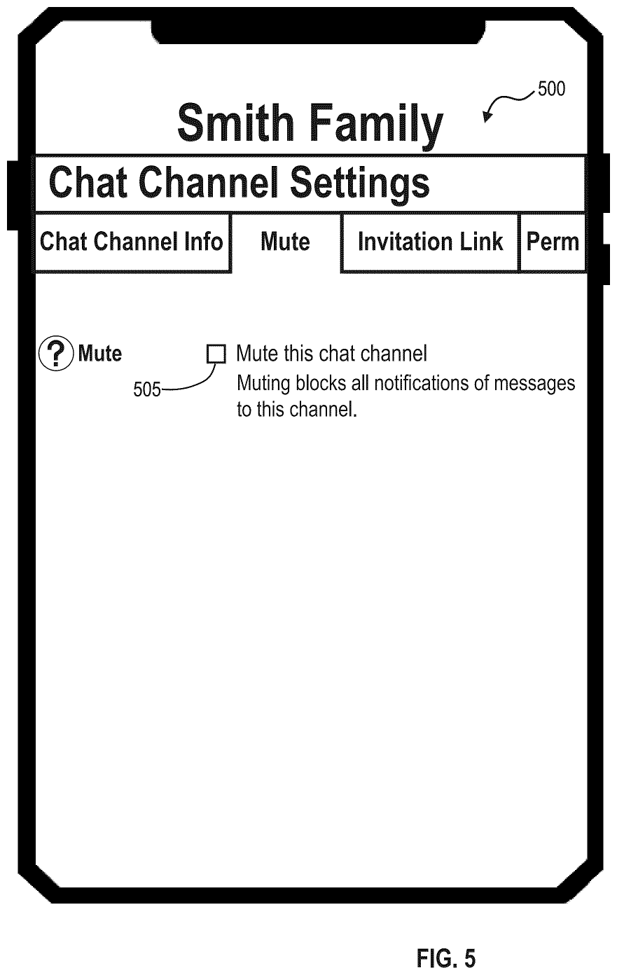

Once the user is logged in to the chat channel 320, the user may decide to activate the mute function in relation to the chat channel 320. As discussed more in relation to FIGS. 5-7, the user may accomplish this, for example, by activating a labeled toggle or selecting an input provided in relation to a user interface associated with settings for the chat channel 320. When the user selects this option, the chat user device 305 may transmit data 335 to the chat server 310 requesting that the chat channel 320 be muted. The chat server 310 may respond by transmitting data 340 to the chat user device 305 indicating that the muting of the chat channel 320 is approved and/or that activates the muting functionality.

In accordance with embodiments of the present invention, the user may also decide to engage the auto-unmute feature in relation to the muted chat channel 320. As already described, the auto-unmute feature provides functionality whereby a channel remains muted until particular search targets are detected in one or more incoming messages. The user may activate the auto-unmute feature by a labeled toggle or selecting an input provided in relation to a user interface associated with settings for the chat channel 320. When the user selects this option, the interface may prompt the user to specify the type of search target. For example, this may be accomplished via a pull down menu by which the user selects a type of search target. Once the type of search target is selected, the user may be prompted to provide further information related to the selected type of search target. For example, the user may be prompted to input a particular keyword if the search target type is keyword or a particular topic if the search target type of topic. In other cases, the user may be asked to select a sentiment type (negative or positive) or a message rate threshold. Once this is done, the chat user device 305 may transmit data 345 to the chat server 310 activating the auto-unmute feature in relation to the muted chat channel 320. The transmitted data 345 may include the associated data provided by the user that specifies the search target. The chat server 310 may respond by transmitting data 350 to the chat user device 305 indicating that the request to activate the auto-unmute feature is approved and initiated in relation to the mute chat channel 320.

The chat server 310 then may transmit data 355 to the message analyzer 315 that communicates the search target specified by the user in relation to the operation of the auto-unmute feature. This data is associated with the chat channel 320.

A new message may then be posted to the chat channel 320. This causes the chat channel 320 to transmit a message 360 to the chat server 310. For the sake of the example, the message is one that includes the search target specified by the user. The chat server 310 then transmits the message 365 to the message analyzer 315, which analyzes the message to detect the search targets. In the example, the message analyzer 315 detects the search target in the message. In response to this, the message analyzer transmits data 370 to the chat server 310 that informs the chat server 310 that the message includes the search target. The chat server 310 then sends the message with an unmute notification 350 to the chat user device 305, which prompts the chat user device 305 to generate a message notification that notifies the user of the message.

In accordance with exemplary embodiments, the message notification for a muted channel may take several forms. In one embodiment, the message notification is simply the message notification that would otherwise accompany a new message when the chat channel is not muted. In other embodiments, the message notification is specially configured to notify the user that the channel is being unmuted due to a search target being detected. In still other embodiments, the message notification queries the user as to whether they would like the channel to remain muted and/or whether the auto-unmute feature should remain activated and the search targets remain the same.

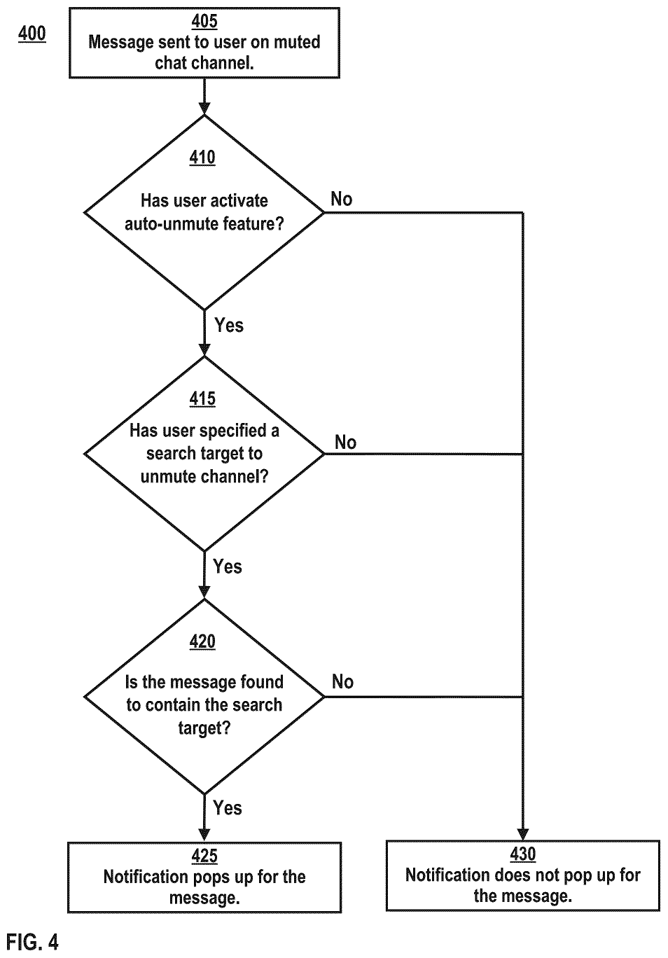

With reference to FIG. 4, a method 400 is provided that demonstrates functionality of the auto-unmute feature in accordance with an exemplary embodiment. The method 400 begins, at step 405, with a message being sent to a chat user on a muted chat channel. At step 410, the method 400 continues by determining if the user has activated the auto-unmute feature in relation to the muted chat channel. If it is determined that “no” the user has not activated the auto-unmute feature, then the method 400 continues to step 430 where the message notification is suppressed. If it is determined that “yes” the user has activated the auto-unmute feature, then the method 400 continues to step 415.

At step 415, the method 400 continues by determining if the user has specified a search target for unmuting the chat channel via operation of the auto-unmute feature. If it is determined that “no” the user has not specified a search target, then the method 400 continues to step 430 where the message notification is suppressed. If it is determined that “yes” the user has specified a search target, then the method 400 continues to step 420.

At step 420, the method 400 continues by determining if the message is found to contain the specified search target. As will be appreciated, this is a determination that is made via analysis provided by the message analyzer. If the message analyzer determines that “no” the search target is not found in the message, then the method 400 continues to step 430 where the message notification is suppressed. On the other hand, if the message analyzer determines that “yes” the search target is found in the message, then the method 400 continues to step 425 where a message notification for the message is generated alerting the user to its arrival.

With general reference now to FIGS. 5-7, one of more interfaces (e.g., user interfaces generated by a chat software application on a user device) may provide information regarding the channel chats that facilitate functionality described in relation to the auto-unmute feature. As will be appreciated, user interfaces for a chat channel may provide information relating to the user, identity of other users within the chat channel, one or more topics to which the chat channel relates, and/or other information. The user interface for a chat channel may enable a user to search for particular information within the chat channel. The user interface for a chat channel may provide alerts or message notifications relating to new messages (e.g., number of messages not yet read by a user) and/or provide information relating to the identities of users who have viewed/interacted with a particular message. The user interface for a chat channel may enable a user to customize views of one or more chats channels, such as by adding one or more feeds to the user interface. Further, the user interface for a chat channel may enable users to provide input that modify settings related to mute and auto-unmute features.

With specific reference to FIG. 5, an exemplary user interface 500 is shown. As will be appreciated, the user interface 500 is a chat interface generated on a smartphone. The user interface 500 is configured to enable a user to provide input that modify settings related to a mute feature. In the example provided, the user has navigated to the user interface 500 to modify a mute setting in relation to a chat channel named “Smith Family”, which may represent a group chat featuring the user's extended family. As shown, the user interface 500 may display the name of the chat channel, i.e., “Smith Family”, in a header portion. Below that, the words “Chat Channel Settings” is provided to indicate the usage associated with the user interface 500. Several categories of settings, or a “settings menu”, is then provided, which includes “Chat Channel Info”, “Mute”, “Invitation Link”, and “Permissions” (the last being partially cut off). Other categories may also be provided.

As indicated in the example of FIG. 5, the user has selected the mute category in the settings menu. With the selection of the mute category, the user interface 500 provides a mute activation input 505. The mute activation input 505 provides an input by which the user can activate the mute feature. It also provides a visual indicator as to whether the mute feature is currently activated or not (e.g., whether a checkmark is included in the input box). Explanatory text, i.e., “Mute this chat channel”, is provided in proximity to the mute activation input 505 so to clearly identify its function. As shown, the mute feature is not currently activated in the user interface 500, as the box provided in the mute activation input 505 is shown as being empty. It will be appreciated that the user interface 500 represents a user interface that may be employed in relation to a conventional mute feature.

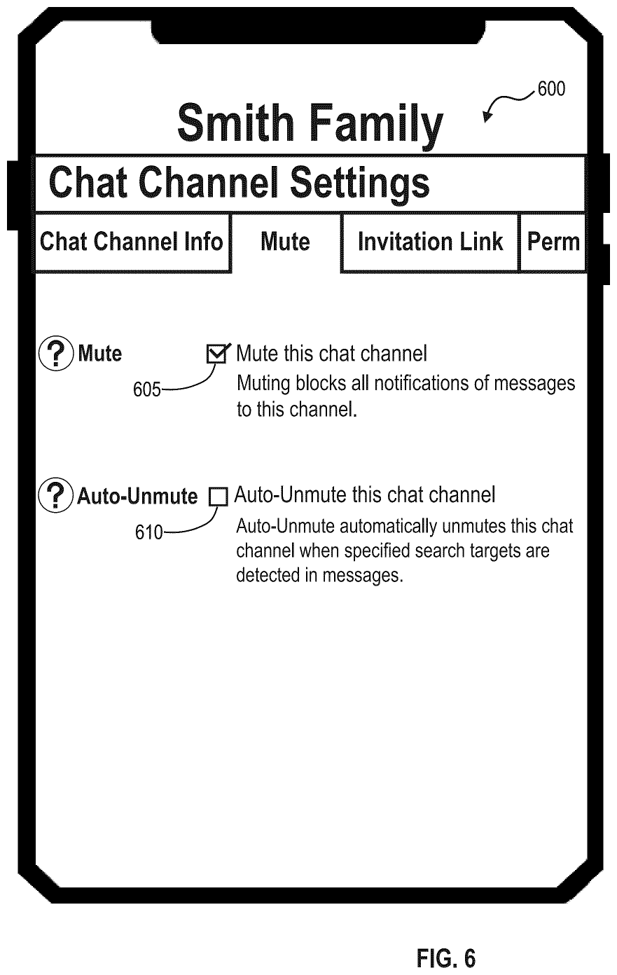

With specific reference to FIG. 6, an exemplary user interface 600 is shown. As will be appreciated, the user interface 600 is a chat interface generated on a smartphone, though it could also be generated on other types of user devices. The user interface 600 is configured to enable a user to provide inputs that modify settings related to both a mute feature and an auto-unmute feature in accordance with embodiments of the present invention. As in the example provided above, the user has navigated to the user interface 600 to modify a mute and unmute settings in relation to a chat channel named “Smith Family”, which, again, may represent a group chat featuring the user's extended family.

With the selection of the mute category, the user interface 600 is generated to show a mute activation input 605, which may perform the same functions as described above in relation to FIG. 5. The user interface 600 also is generated to show an auto-unmute activation input 610, which provides an input feature by which the user can activate the auto-unmute feature. The auto-unmute activation input 610 also provides a visual indicator as to whether the mute feature is currently activated or not (e.g., whether a checkmark is included in the input box). Explanatory text, i.e., “Auto-Unmute this chat channel”, is provided in proximity to the auto-unmute activation input 610 so to clearly identify its function. As shown in the illustrated example, the mute feature is currently activated in the user interface 600, as the box provided in the mute activation input 605 is shown as including a checkmark. As further shown in the illustrated example, the auto-unmute feature is currently not activated in the user interface 600, as the box provided in the auto-unmute activation input 610 is shown as being empty. It will be appreciated that the user interface 600 represents a user interface that may be employed in relation to mute and auto-unmute features of the present invention. Additionally, functionality may suppress a user from activating the auto-unmute activation input 610 until the mute activation input has been activated.

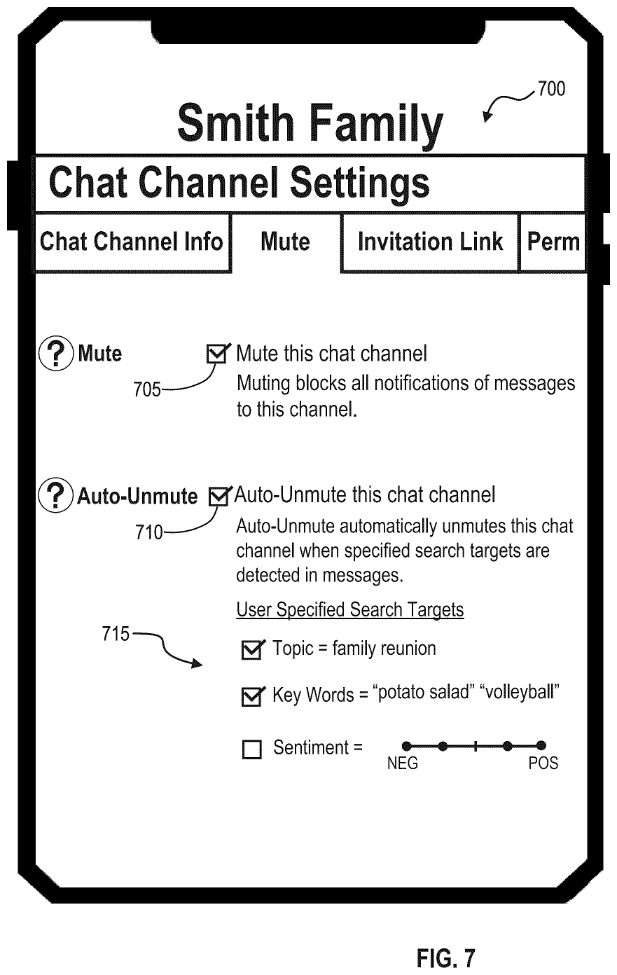

With specific reference to FIG. 7, an exemplary user interface 700 is shown that provides for the user entering one or more search targets upon the activation of the auto-unmute feature. As indicated, once the user activates the auto-unmute feature (i.e., by activating the mute activation feature 705 and then activating the auto-unmute activation input 710), search target inputs 715 are generated in the user interface 700 to provide a way for the user to specify the search targets. Such search target inputs 715 can be generated for any type of search target described herein. In the example of FIG. 7, the type of search targets available to the user include a “Topic” search target, a “Keywords” search target, and a “Sentiment” search target. In the example provided, the user decided to mute his family chat channel due to the flood of notifications occurring between certain family members in regard to a topic that the user is not interested in. However, the user is interested in messages regarding the planning of an upcoming family reunion. Thus, the user has activated the Topic search target and input the term “family reunion”. Additionally, the user has input a couple of keywords or phrases that relate to that topic, i.e., “potato salad” and “volleyball”. The user has not activated the Sentiment search target, but if the user had, a slider is provided that would allow the user to indicate a range of negative and positive sentiment. With the settings configured in this manner, the user should be unbothered by message notifications that are not about the upcoming family reunion while still receiving notifications in regard to those that are.

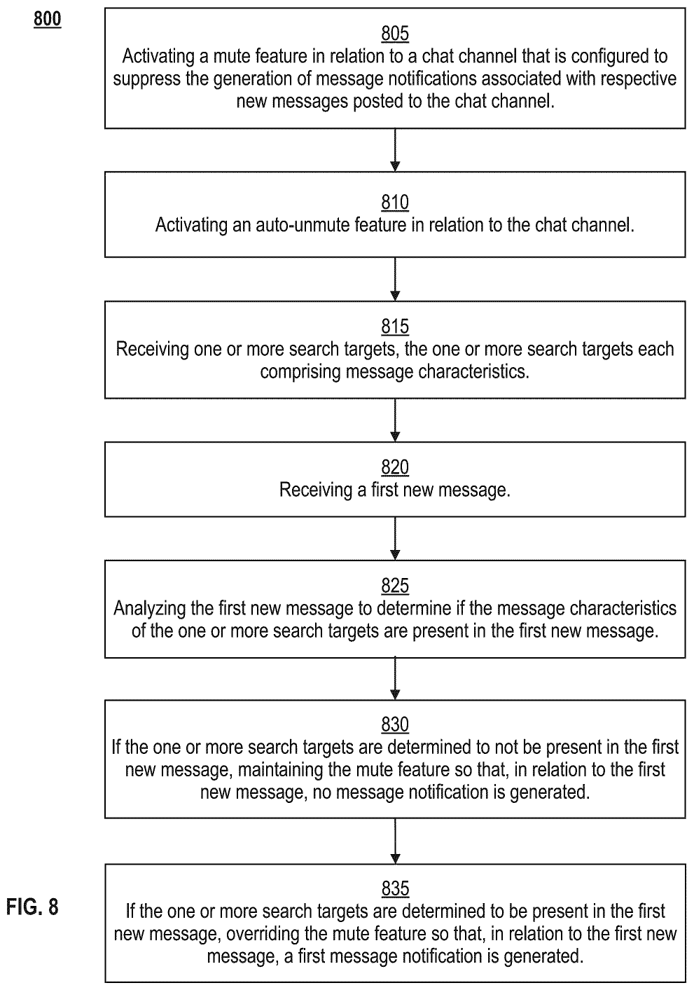

With reference now to FIG. 8, an exemplary method 800 is shown that illustrates an embodiment of the present invention. The method 800 is a computer-implemented method for selectively generating message notifications in relation to respective messages to a user via a user device. As will be appreciated, the messages are text-based chat messages posted on a chat channel to which the user is subscribed.

The method 800 begins, at step 805, by activating a mute feature in relation to the chat channel. As will be appreciated, the mute feature, once activated, may be configured to suppress a generation of message notifications associated with respective new messages posted to the chat channel. As used herein, the new messages are defined as the messages posted to the chat channel subsequent to the activation of the mute feature. As discussed above, in exemplary embodiments, the activating the mute feature in relation to the chat channel further may include the steps of: generating a first user interface that includes a mute activation input in relation to the chat channel; and receiving a first input from the user in relation to the mute activation input. The mute feature is the activated in response to receiving the first input. As described, the mute feature may function to suppress message notifications. Such message notifications may include both a visual indicator and a sound indicator that are generated in real time for alerting a user of a message being posted to the chat channel. The visual indicator may include a pop up notification generated in a user interface. The sound indicator may include a notification noise generated by the user device.

At step 810, the method 800 continues by activating an auto-unmute feature in relation to the chat channel. As discussed above, in exemplary embodiments, the activating the auto-unmute feature in relation to the chat channel may include the steps of: generating the first user interface to further include an auto-unmute activation input in relation to the chat channel; receiving a second input from the user in relation to the auto-unmute activation input; generating the first user interface to further include one or more search targets inputs corresponding to respective ones of the one or more search targets; and receiving a third input from the user in relation to the one or more search target inputs, the third input including information provided by the user specifying at least one of the one or more search targets. The auto-unmute feature is then activated in response to receiving the second and third inputs. In exemplary embodiments, the first user interface may provide multiple search target inputs for the user to choose between. For example, at least two search target inputs may be provided that correspond to at least two different types of search targets. Further, the two search target inputs may be configured in the first user interface to allow the user to select therebetween in accordance with preferred ones. In this way, the auto-unmute feature can be activated by a user in relation to operate pursuant to a single search target type or multiple search target types in accordance with user preference.

At step 815, the method 800 continues by receiving one or more search targets. The one or more search targets each are defined as a message characteristic. In exemplary embodiments, the one or more search targets may include a topic search target. In other embodiments, the one or more search targets may include a keyword search target. In other embodiments, the one or more search targets may include: a first search target that comprises either a keyword search target or a topic search target; and a sentiment search target that can be used in conjunction with the first search target. Other types of search targets may be provided as discussed above.

In certain embodiments, the remaining steps may be part of a subprocess that is performed in relation to each new message on the chat channel when the auto-unmute feature is activated. The subprocess may be used to selectively overriding the mute feature in relation to the new messages. When described in relation to an exemplary first new message of the new messages that is representative as to how the subprocess operates in relation to each of the new messages, the subprocess may include the following steps.

At step 820, the method 800 continues by receiving the first new message.

At step 825, the method 800 continues by analyzing the first new message to determine if the message characteristics of the one or more search targets are present in the first new message. In certain embodiments, the analyzing the first new message to determine if the one or more search targets are present includes analyzing the first new message in context with a predetermined number of other new messages that were posted to the chat channel just prior to the first new message. In this way, the analysis of the first new message receives the benefit of context, which, for example, may prove useful in determining if certain topics are being discussed. Wherein the one or more search targets include at least two search targets, functionality may depend in accordance with alternative embodiments. For example, in certain embodiments, it may be required that both search targets be determined as present in the first new message to override the mute feature. In other embodiments, it may be required that only one of the two search targets be determined to be present in the first new message to override the mute feature. In certain embodiments, the user may select between such modes of operation.

At step 830, the method 800 continues by maintaining, if the one or more search targets are determined to not be present in the first new message, the mute feature so that, in relation to the first new message, no message notification is generated.

At step 835, the method 800 continues by overriding, if the one or more search targets are determined to be present in the first new message, the mute feature so that, in relation to the first new message, a first message notification is generated. In certain embodiments, the first message notification is configured to include additional elements than message notifications generated when a channel is not muted. For example, the first message notification may include a communication notifying the user that it relates to a message posted to a chat channel that had been previously muted by the user. This will allow the user to know the message likely pertains to a subject or topic of interest. In other embodiments, the first message notification includes a query in which the user is asked whether the chat channel should remain muted or should be unmuted.

In exemplary embodiments, the user device is a smart phone. In other embodiments, the user device is a desktop or laptop computer. In such cases, the user may be an agent of a contact center, as embodiments of the present invention may prove particularly useful at monitoring group customer chat channels or channels devoted to a product or business enterprise. In such cases, for example, the one or more search targets may include: a first search target that is either a keyword search target or a topic search target; and a sentiment search target that can be used in conjunction with the first search target. In this way, the agent is notified as to when extreme sentiment accompanies a particular topic or keyword describing a product or business.

As one of skill in the art will appreciate, the many varying features and configurations described above in relation to the several exemplary embodiments may be further selectively applied to form the other possible embodiments of the present invention. For the sake of brevity and taking into account the abilities of one of ordinary skill in the art, each of the possible iterations is not provided or discussed in detail, though all combinations and possible embodiments embraced by the several claims below or otherwise are intended to be part of the instant application. Further, it should be apparent that the foregoing relates only to the described embodiments of the present application and that numerous changes and modifications may be made herein without departing from the spirit and scope of the present application as defined by the following claims and the equivalents thereof.

That which is claimed:

1. A computer-implemented method of selectively generating message notifications in relation to respective messages to a user via a user device, wherein the messages each comprises a text-based chat message posted on a chat channel to which the user is subscribed, the method comprising:
activating a mute feature in relation to the chat channel, wherein the mute feature, once activated, is configured to suppress a generation of message notifications associated with respective new messages posted to the chat channel, wherein the new messages comprise ones of the messages posted to the chat channel subsequent to the activation of the mute feature;
activating an auto-unmute feature in relation to the chat channel;
receiving one or more search targets, the one or more search targets each comprising message characteristics; and
performing, when the auto-unmute feature is activated, a first process for selectively overriding the mute feature in relation to the new messages, wherein, when described in relation to an exemplary first new message of the new messages that is representative as to how the first process operates in relation to each of the new messages, the first process comprises:
receiving the first new message;
analyzing the first new message to determine if the message characteristics of the one or more search targets are present in the first new message;
if the one or more search targets:
are determined to not be present in the first new message, maintaining the mute feature so that, in relation to the first new message, no message notification is generated; and
are determined to be present in the first new message, overriding the mute feature so that, in relation to the first new message, a first message notification is generated.

2. The method of claim 1, wherein the activating the mute feature in relation to the chat channel further comprises:
generating a first user interface that includes a mute activation input in relation to the chat channel; and
receiving a first input from the user in relation to the mute activation input;
wherein the mute feature is activated in response to receiving the first input.

3. The method of claim 2, wherein the activating the auto-unmute feature in relation to the chat channel comprises:
generating the first user interface to further include an auto-unmute activation input in relation to the chat channel; and
receiving a second input from the user in relation to the auto-unmute activation input.

4. The method of claim 3, wherein the activating the auto-unmute feature in relation to the chat channel comprises:
generating the first user interface to further include one or more search targets inputs corresponding to respective ones of the one or more search targets; and
receiving a third input from the user in relation to the one or more search target inputs, the third input comprising information provided by the user specifying at least one of the one or more search targets;
wherein the auto-unmute feature is activated in response to receiving the second and third inputs.

5. The method of claim 4, wherein the one or more search target inputs comprise at least two search target inputs corresponding to at least two respective ones of the one or more search targets;
wherein the at least two search target inputs are configured in the first user interface to allow the user to select therebetween so that the auto-unmute feature can be activated in relation to one or more of the at least two search targets in accordance with a preference of the user.

6. The method of claim 1, wherein the analyzing the first new message to determine if the one or more search targets are present comprises analyzing the first new message in context with a predetermined number of other new messages that were posted to the chat channel just prior to the first new message.

7. The method of claim 1, wherein the one or more search targets comprise a topic search target.

8. The method of claim 1, wherein the one or more search targets comprise a keyword search target.

9. The method of claim 1, wherein the one or more search targets includes a topic search target that can be used in conjunction with a sentiment search target.

10. The method of claim 1, wherein the one or more search targets includes a keyword search target that can be used in conjunction with a sentiment search target.

11. The method of claim 1, wherein the one or more search targets includes:
a first search target that comprises either a keyword search target or a topic search target; and
a sentiment search target that can be used in conjunction with the first search target.

12. The method of claim 1, wherein the one or more search targets comprises two search targets; and
wherein both of the two search targets must be determined as present in the first new message to override the mute feature.

13. The method of claim 1, wherein the one or more search targets comprises two search targets; and
wherein at least one of the two search targets must be determined to be present in the first new message to override the mute feature.

14. The method of claim 1, wherein the user device comprises a smart phone.

15. The method of claim 1, wherein the user device comprises a desktop or laptop computer and the user comprises an agent of a contact center; and
wherein the one or more search targets includes:
a first search target that comprises either a keyword search target or a topic search target; and
a sentiment search target that can be used in conjunction with the first search target.

16. The method of claim 1, wherein the message notifications comprises both a visual indicator and a sound indicator that are generated in realtime for alerting user of a message being posted to the chat channel;
wherein:
the visual indicator comprises a pop up notification generated in a user interface; and
the sound indicator comprises a notification noise generated by the user device.

17. The method of claim 1, wherein the first message notification includes a communication notifying the user that the first message notification relates to a message posted to a chat channel that had been muted by the user via activating the mute feature.

18. The method of claim 17, wherein the first message notification includes a query in which the user is asked whether the chat channel should remain muted.

19. A system for selectively generating message notifications in relation to respective messages to a user via a user device, wherein the messages each comprises a text-based chat message posted on a chat channel to which the user is subscribed, the system comprising:
a processor; and
a memory storing instructions which, when executed by the processor, cause the processor to perform the steps of:
activating an auto-unmute feature in relation to the chat channel;
receiving one or more search targets, the one or more search targets each comprising message characteristics; and
performing, when the auto-unmute feature is activated, a first subprocess for selectively overriding the mute feature in relation to the new messages, wherein, when described in relation to an exemplary first new message of the new messages that is representative as to how the first subprocess operates in relation to each of the new messages, the first subprocess comprises:
receiving the first new message;
analyzing the first new message to determine if the message characteristics of the one or more search targets are present in the first new message;
if the one or more search targets:
are determined to not be present in the first new message, maintaining the mute feature so that, in relation to the first new message, no message notification is generated; and
are determined to be present in the first new message, overriding the mute feature so that, in relation to the first new message, a first message notification is generated.

20. The system of claim 19, wherein the one or more search targets includes:
a first search target that comprises either a keyword search target or a topic search target; and
a sentiment search target that can be used in conjunction with the first search target.
